(19) United States
(12) Patent Application Publication
(10) Pub. No.: US 2018/0165900 A1
(43) Pub. Date: Jun. 14, 2018

(54) INTELLIGENT AUTHENTICATION SYSTEM AND ELECTRONIC KEY THEREOF

(71) Applicant: E Ink Holdings Inc., Hsinchu (TW)

(72) Inventors: Jia-Hong Xu, Hsinchu (TW); Chuen-Jen Liu, Hsinchu (TW)

(73) Assignee: E Ink Holdings Inc., Hsinchu (TW)

(21) Appl. No.: 15/893,722

(22) Filed: Feb. 12, 2018

Related U.S. Application Data
(63) Continuation-in-part of application No. 14/857,831, filed on Sep. 18, 2015.

(30) Foreign Application Priority Data
Jul. 23, 2015 (TW) 104123815
Mar. 14, 2017 (CN) 201710148838.9

(51) Int. Cl. G07C 9/00; G09G 3/34

(52) U.S. Cl. CPC G07C 9/00119; G09G 3/344; G07C 2009/00777; G07C 2009/00412; G09G 2358/00

(57) ABSTRACT

An intelligent authentication system including an electronic lock and an electronic key is provided. The electronic key includes an electronic paper display apparatus. The electronic key is adapted to perform a two-step authentication with the electronic lock. The two-step authentication includes the first authentication step and the second authentication step. The electronic paper display apparatus is driven after the first authentication step is passed. And during the second authentication step, the electronic key performs an authentication operation with the electronic lock by using the driven electronic paper display apparatus. Furthermore, an electronic key for the foregoing intelligent authentication system is also provided.

### CROSS-REFERENCE TO RELATED APPLICATION

This application is a continuation-in-part application of and claims the priority benefit of a prior application Ser. No. 14/857,831, filed on Sep. 18, 2015, now pending. The prior application Ser. No. 14/857,831 claims the priority benefit of Taiwan application serial no. 104123815, filed on July 23, 2015. This application also claims the priority benefit of China application serial no. 201710148838.9, filed on Mar. 14, 2017. The entirety of the above-mentioned patent application is hereby incorporated by reference herein and made a part of this specification.

### BACKGROUND OF THE INVENTION

### Field of the Invention

The invention relates to an intelligent authentication system and an electronic key thereof and particularly relates to an intelligent authentication system and an electronic key of the intelligent authentication system which transmits an encrypted signal through an electronic paper display apparatus.

### Description of Related Art

An electronic paper display apparatus is a new type of display apparatus, which has features of high color contrast, high resolution, small power consumption, low manufacturing cost, etc. In recent years, since display apparatuses are gradually developed towards a trend of light and slim, the electronic paper display apparatus becomes a display apparatus meeting the needs of the public. Since the electronic paper display apparatus has the advantages of light, slim, durable in use and low power consumption in line with energy saving and environmental protection, etc., the electronic paper display apparatus has been widely applied in electronic readers (for example, electronic books, electronic newspapers) or other electronic components (for example, electronic tags). In the application field of the electronic tag, one of the most commonly used recognition techniques is a radio frequency identification (RFID) technique.

By combining the RFID technique with an integrated circuit (IC) chip, a read device or a read-write device may be used to read information of the IC chip through a wireless manner. However, regarding some IC chips required to be kept confidential, confidential information stored therein are probably analyzed and duplicated without permission.

Commonly used intelligent electronic locks include combination locks as well as locks using recognition techniques, such as near field communication (NFC), radio frequency identification (RFID), Bluetooth identification, biometric features recognition, and so forth. It is possible for the information exchanged through NFC, RFID, or Bluetooth identification to be stolen or be decoded during communication because the signals are in an open field. As for biometric features recognition, misjudgment is likely to occur, and thus the stability of such a technique has been continuously challenged.

### SUMMARY OF THE INVENTION

In view of the above, embodiments of the invention provide an intelligent authentication system and an electronic key thereof The intelligent authentication system transmits an encrypted signal through an electronic paper display apparatus, so as to perform an authentication operation between an electronic lock and the electronic key.

An embodiment of the invention provides an intelligent authentication system that includes an electronic lock and an electronic key. The electronic key includes the electronic paper display apparatus. The electronic key and the electronic lock perform a two-step authentication. The two-step authentication includes a first authentication step and a second authentication step. The electronic paper display apparatus is driven after the first authentication step is passed. The electronic key performs an authentication operation with the electronic lock during the second authentication step by using the driven electronic paper display apparatus.

In an embodiment of the invention, the electronic key further includes an induction coil. The induction coil performs another authentication operation with the electronic lock during the first authentication step through near field communication (NFC). The induction coil outputs an operating electricity power to the electronic paper display apparatus to drive the electronic paper display apparatus after the first authentication step is passed.

In an embodiment of the invention, the electronic lock includes an image sensing apparatus. The electronic lock performs an authentication operation with the electronic key by using the image sensing apparatus. The electronic paper display apparatus alternately displays a first image and a second image during the second authentication step, so as to transmit an encrypted signal. The image sensing apparatus receives and decodes the encrypted signal during the second authentication step, so as to obtain an information contained in the encrypted signal to perform the authentication operation.

In an embodiment of the invention, the encrypted signal includes a combination of the first image and the second image displayed by the electronic paper display apparatus during the second authentication step.

In an embodiment of the invention, the electronic paper display apparatus is driven by a driving signal. The driving signal includes a first frequency and a second frequency. The driving signal of the first frequency drives the electronic paper display apparatus to transmit an encoded signal contained in the encrypted signal. The driving signal of the second frequency drives the electronic paper display apparatus to transmit another encoded signal contained in the encrypted signal. The first frequency is not equal to the second frequency.

In an embodiment of the invention, the electronic paper display apparatus is driven by a driving signal of a plurality of different frequencies to transmit one of a plurality of encoded signals contained in the encrypted signal. The encoded signals transmitted by the electronic paper display apparatus are determined by a combination of the different frequencies.

In an embodiment of the invention, the image sensing apparatus includes an image sensor and a data processor. The image sensor is configured to receive and output an encrypted signal. The data processor is electrically connected to the image sensor and configured to decode the encrypted signal, so as to obtain information contained in the encrypted signal.

In an embodiment of the invention, the image sensor emits a sensing signal to the electronic paper display apparatus. The electronic paper display apparatus feeds back the sensing signal to the image sensor, such that the image sensor receives the encrypted signal. The electronic paper display apparatus displaying the first image absorbs at least a part of the sensing signal. The electronic paper display apparatus displaying the second image reflects at least a part of the sensing signal.

An embodiment of the invention provides an electronic key adapted to an intelligent authentication system as above mentioned.

Based on the above, the intelligent electronic lock provided in the embodiment of the invention is the intelligent authentication system having the electronic paper display apparatus. The intelligent authentication system alternately displays different images by using the electronic paper display apparatus, so as to encrypt to-be-transmitted information in the images alternately displayed and transmit the encrypted signal. The security in authentication is thereby increased.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic diagram of an electronic paper display apparatus according to an embodiment of the invention.

FIG. 2A is a schematic diagram illustrating a situation that an electronic paper display panel is driven by a driving signal to display a first image according to an embodiment of the invention.

FIG. 2B is a schematic diagram illustrating a situation that an electronic paper display panel is driven by a driving signal to display a second image according to an embodiment of the invention.

FIG. 3A is a waveform schematic diagram of a driving signal corresponding to an encoded signal according to an embodiment of the invention.

FIG. 3B is a waveform schematic diagram of a driving signal corresponding to an encoded signal according to another embodiment of the invention.

FIG. 4 is a schematic diagram of a signal transmission system according to an embodiment of the invention.

FIG. 5 is a flowchart illustrating a signal transmission method according to an embodiment of the invention.

FIG. 6 is a schematic diagram of a plurality of display regions of an electronic paper display panel according to an embodiment of the invention.

FIG. 7 is a schematic diagram of an intelligent authentication system according to an embodiment of the invention.

### DESCRIPTION OF THE EMBODIMENTS

Reference will now be made in detail to the embodiments of the invention, examples of which are illustrated in the accompanying drawings. Wherever possible, the same reference numbers are used in the drawings and the description to refer to the same or like parts.

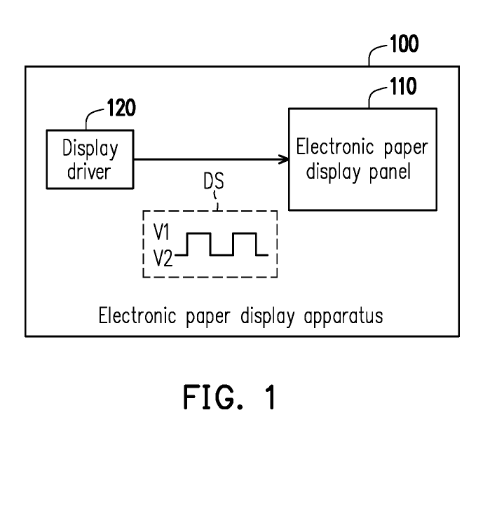

FIG. 1 is a schematic diagram of an electronic paper display apparatus according to an embodiment of the invention. Referring to FIG. 1, in the present embodiment, the electronic paper display apparatus 100 includes an electronic paper display panel 110 and a display driver 120. The electronic paper display panel 110 is driven by the display driver 120, and is configured to display a first image or a second image. In the present embodiment of the invention, in the electronic paper display panel 110, black display particles and white display particles are respectively taken as display media. In the present embodiment, a black image and a white image displayed by the electronic paper display panel 110 are taken as the first image and the second image for description, though the invention is not limited thereto.

In the present embodiment, the display driver 120 is electrically connected to the electronic paper display panel 110, and is configured to output a driving signal DS to the electronic paper display panel 110. In the present embodiment, the display driver 120 may be configured with a signal generator, and the signal generator generates an internal signal to the display driver 120, such that the display driver 120 outputs the driving signal DS to the electronic paper display panel 110. In an embodiment, the display driver 120 may also receive an external signal, and outputs the driving signal

DS to the electronic paper display panel 110 according to the received external signal. The method that the display driver 120 generates and outputs the driving signal DS is not limited by the invention. Therefore, in the present embodiment, the display driver 120 drives the electronic paper display panel 110 to alternately display the first image and the second image to transmit an encrypted signal by using the driving signal DS during a signal transmission period.

To be specific, in the present embodiment, the driving signal DS includes a first signal level V1 and a second signal level V2, as shown in FIG. 1, though the invention is not limited thereto. The display driver 120 drives the electronic paper display panel 110 to display the first image by using the driving signal DS of the first signal level V1. Moreover, the display driver 120 drives the electronic paper display panel 110 to display the second image by using the driving signal DS of the second signal level V2.

In detail, in the electronic paper display panel 110 of the present embodiment, since the black display particles and the white display particles are taken as the display media, when the electronic paper display panel 110 is subjected to a negative electric field, it displays a white image, and when the electronic paper display panel 110 is subjected to a positive electric field, it displays a black image. Therefore, the driving signal DS of the present embodiment includes the first signal level V1 and the second signal level V2, where the first signal level V1 is higher than the second signal level V2, though the invention is not limited thereto. In this way, the display driver 120 may drive the electronic paper display panel 110 to display the first image (i.e. the black image) by using the first signal level V1 with the positive electric field, and drive the electronic paper display panel 110 to display the second image (i.e. the white image) by using the second signal level V2 with the negative electric field.

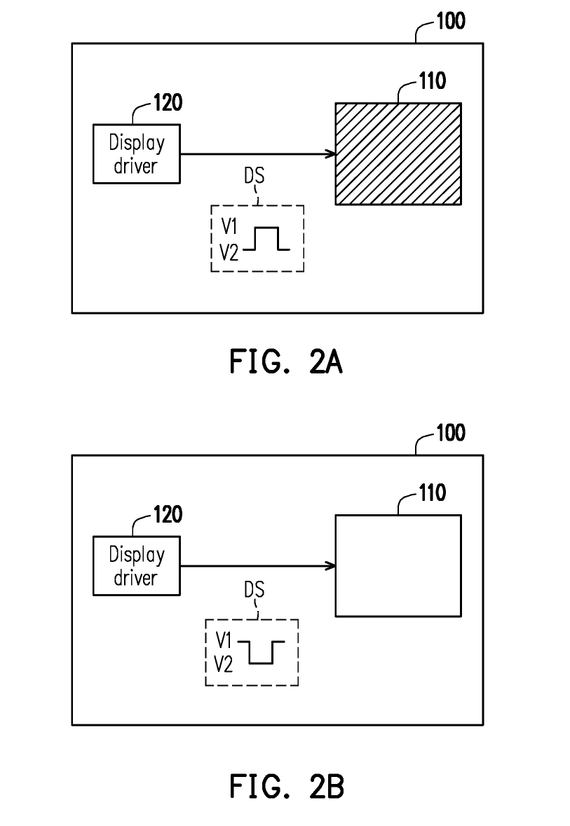

In other words, the electronic paper display panel 110 of the present embodiment may be driven by the driving signals of different signal levels to display the corresponding images, and referring to FIG. 2A and FIG. 2B for detailed descriptions thereof, FIG. 2A is a schematic diagram illustrating a situation that the electronic paper display panel 110 is driven by the driving signal DS to display the first image according to an embodiment of the invention, and FIG. 2B is a schematic diagram illustrating a situation that the electronic paper display panel 110 is driven by the driving signal DS to display the second image according to an embodiment of the invention.

Namely, since the electronic paper display panel 110 may be driven by the driving signal DS of different signal levels to display the corresponding images, when the driving signal DS output by the display driver 120 has a signal waveform composed of a series of the first signal levels V1 and the second signal levels V2 (shown as the driving signal DS of FIG. 1), the electronic paper display panel 110 may alternately display the first image and the second image according to the first signal level V1 and the second signal level V2 of the driving signal DS. Therefore, the electronic paper display apparatus 100 may transmit signals based on the characteristic that the electronic paper display panel 110 may be driven by the driving signal DS of different signal levels to display the corresponding images.

It should be noted that since the electronic paper display panel 110 has an image switching speed of a millisecond level, the image switching speed thereof is very fast. Therefore, when the electronic paper display panel 110 transmits a signal by switching different images, such signal is hard to be duplicated and stolen. Besides, the display driver 120 of the present embodiment may further perform an encoding process to the received internal signal or external signal, so as to output the encoded driving signal DS. Therefore, in the present embodiment, the driving signal DS contains an encrypted signal to be transmitted by the electronic paper display panel 110. In this way, during the signal transmission period, and driven by the driving signal DS, a combination of the first image and the second image displayed by the electronic paper display panel 110 includes the encrypted signal, such that the electronic paper display apparatus 100 may transmit the encrypted signal by using the electronic paper display panel 110 to alternately display the first image and the second image, so as to greatly improve security of the signal transmission.

Regarding the aforementioned encoding process, the display driver 120 may define an encoding method thereof according to different requirements, for example, the display driver 120 may encode the internal signal or the received external signal according to a time length, a frequency or a specific encoding rule (for example, according to the rule of the Moss code), so as to encrypt the internal or external signal to generate the driving signal DS containing the encrypted signal, though the invention is not limited to the above encoding method.

In an embodiment, the encoding method adopted by the electronic paper display apparatus 100 is, for example, to define different encoded signals according to a magnitude of the frequency. In the present embodiment, the display driver 120 drives the electronic paper display panel 110 by using the driving signal DS of a first frequency, such that the electronic paper display panel 110 transmits an encoded signal in the encrypted signal. The display driver 120 drives the electronic paper display panel 110 by using the driving signal DS of a second frequency, such that the electronic paper display panel 110 transmits another encoded signal in the encrypted signal. In the present embodiment, the first frequency is not equal to the second frequency.

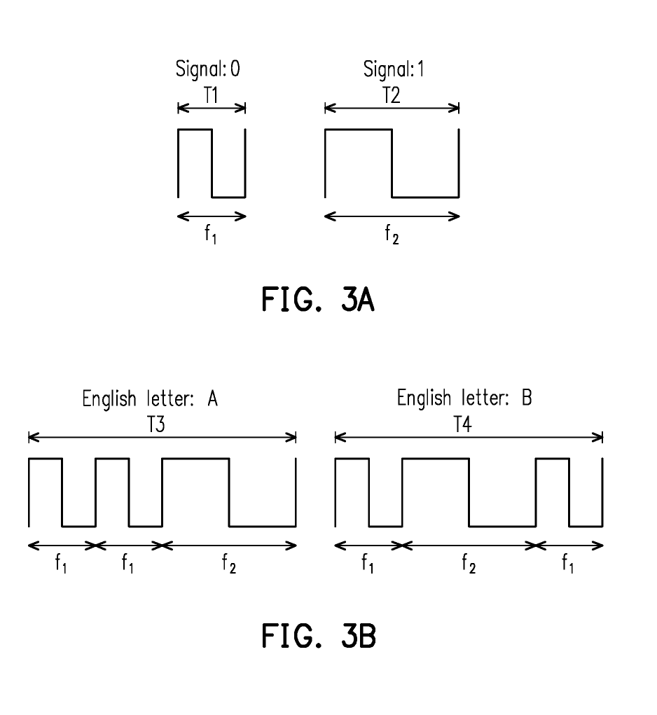

FIG. 3A is a waveform schematic diagram of a driving signal corresponding to the encoded signal according to an embodiment of the invention. Referring to FIG. 3A, for example, in the present embodiment, the display driver 120 drives the electronic paper display panel 110 by using the driving signal DS of different frequencies, so as to encrypt different signals to be transmitted, for example, a signal 0 and a signal 1. In the present embodiment, regarding the driving signal DS of the first frequency f1, the encoded signal thereof, for example, represents the signal 0, and regarding the driving signal DS of the second frequency f2, the encoded signal thereof, for example, represents the signal 1. In the present embodiment, the first frequency f1 is not equal to the second frequency f2. In this way, during a signal transmission period T1, the driving signal DS of the first frequency f1 is switched between the first signal level and the second signal level, and the electronic paper display panel 110 driven by the driving signal DS alternately displays the first image and the second image in the first frequency f1, to as to transmit the signal 0 in the encrypted signal. In the present embodiment, during a signal transmission period T2, the driving signal DS of the second frequency f2 is switched between the first signal level and the second signal level, and the electronic paper display panel 110 driven by the driving signal DS alternately displays the first image and the second image in the second frequency f2, to as to transmit the signal 1 in the encrypted signal. The waveform and the corresponding encoded signal of the driving signal DS shown in FIG. 3A are only an example, and the invention is not limited thereto. In other embodiments, the electronic paper display apparatus 100 may respectively encrypt numbers, English letters or other symbols to be transmitted according to different frequencies, which is not limited by the invention.

In another embodiment of the invention, the display driver 120 drives the electronic paper display panel 110 by using the display signal DS of a plurality of different frequencies, such that the electronic paper display panel 110 transmits one of a plurality of encoded signals in the encrypted signal. In the present exemplary embodiment, the encoded signals transmitted by the electronic paper display panel 110 are determined according to combinations of different frequencies.

For example, FIG. 3B is a waveform schematic diagram of a driving signal corresponding to the encoded signal according to another embodiment of the invention. In the present embodiment, the display driver 120 drives the electronic paper display panel 110 by using the driving signal DS having different frequency combinations, so as to encrypt different signals to be transmitted, for example, English letters A and B. Referring to FIG. 3B, in the present embodiment, during a signal transmission period T3, the frequency of the driving signal DS is changed from the first frequency f1 to the second frequency f2, and the encoded signal formed by a combination thereof, for example, represents the English letter A. During a signal transmission period T4, the frequency of the driving signal DS is changed from the first frequency f1 to the second frequency f2, and is again changed from the second frequency f2 to the first frequency f1, and the encoded signal formed by a combination thereof, for example, represents the English letter B. In the present embodiment, the first frequency f1 is also different to the second frequency f2. Therefore, the electronic paper display panel 110 driven by the driving signal DS may switch the displayed images according to a changing sequence of the first frequency f1 and the second frequency f2, so as to transmit the English letters A and B in the encrypted signal. The waveform and the corresponding encoded signal of the driving signal DS shown in FIG. 3B are only an example, and the invention is not limited thereto. In other embodiments, the electronic paper display apparatus 100 may respectively encrypt numbers, English letters or other symbols to be transmitted according to combinations of more different frequencies, which is not limited by the invention.

In the present embodiment, the electronic paper display apparatus may first encode the internal signal or the received external signal to generate the driving signal containing the encrypted signal. Then, the electronic paper display panel may be driven by the driving signal of different signal levels to display the corresponding images. In this way, the electronic paper display apparatus may alternately display different images to transmit the encrypted signal during the signal transmission period. Therefore, confidentiality and security of the signal transmission are enhanced.

On the other hand, by using the aforementioned electronic paper display apparatus and the signal transmission method thereof, if the transmitted encrypted signal is required to be read out, an image sensing apparatus may be configured to sense the images displayed by the electronic paper display apparatus 100, so as to decode the encrypted signal. In the following embodiment, a structure of a signal transmission system having the electronic paper display apparatus is further illustrated.

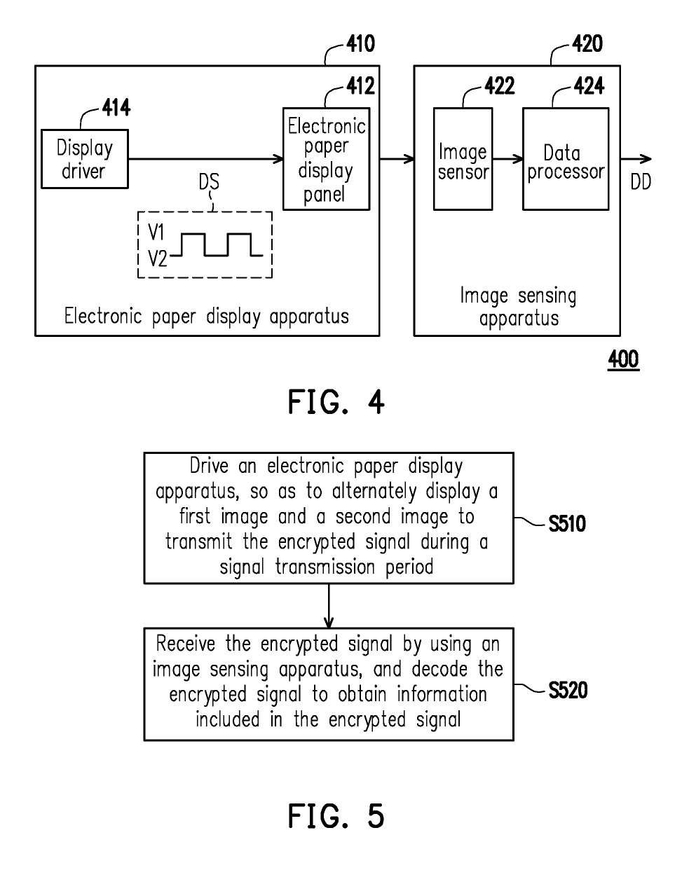

FIG. 4 is a schematic diagram of a signal transmission system according to an embodiment of the invention. Referring to FIG. 4, the signal transmission system 400 of FIG. 4 includes an electronic paper display apparatus 410 and an image sensing apparatus 420. Description of the electronic paper display apparatus 410 and the electronic paper display panel 412, the display driver 414 and the driving signal DS thereof may be deduced by referring to related description of the electronic paper display apparatus 100 of FIG. 1 and the electronic paper display panel 110, the display driver 120 and the driving signal DS thereof, and details thereof are not repeated.

In the present embodiment, the image sensing apparatus 420 is configured to receive and decode an encrypted signal transmitted by the electronic paper display apparatus 410, so as to obtain an information contained in the encrypted signal. In the present embodiment, the image sensing apparatus 420 includes an image sensor 422 and a data processor 424. The image sensor 422 may be implemented by an infrared sensing device, a charge coupled device (CCD) or a complementary metal oxide semiconductor (CMOS), which is not limited by the invention. The image sensor 422 is configured to receive the encrypted signal transmitted by the electronic paper display apparatus 410, and output the encrypted signal to the post data processor 424.

In the present embodiment, the data processor 424 is electrically connected to the image sensor 422, and is configured to decode the encrypted signal to obtain the information included in the encrypted signal. The data processor 424 is, for example, a central processing unit (CPU), or other programmable general purpose or special purpose microprocessor, a digital signal processor (DSP), a programmable controller, application specific integrated circuits (ASIC), a programmable logic device (PLD) or other similar devices or a combination of these devices, which is not limited by the invention. An embodiment is provided below to describe detailed steps of a signal transmission method below.

FIG. 5 is a flowchart illustrating a signal transmission method according to an embodiment of the invention. Referring to FIG. 5, the signal transmission method of the present embodiment is at least adapted to the electronic paper display apparatus 410 and the image sensing apparatus 420 of FIG. 4. Detailed steps of the signal transmission method of the present embodiment are described below with reference of the electronic paper display apparatus 410 and the image sensing apparatus 420.

First, in step S510, at the emitting end, the display driver 414 drives the electronic paper display panel 412 of the electronic paper display apparatus 410 to alternately display the first image and the second image during the signal transmission period, so as to transmit the encrypted signal. In the present embodiment, similar to the embodiment of FIG. 1, the electronic paper display panel 412 also adopts the black display particles and the white display particles to serve as display media, though the invention is not limited thereto. During the signal transmission period, the electronic paper display apparatus 410 may alternately display the first image constructed by, for example, the black display particles and the second image constructed by, for example, the white display particles to transmit the encrypted signal.

In step S520, at the receiving end, the signal transmission system 400 receives and decodes the encrypted signal by using the image sensing apparatus 420, so as to obtain the information included in the encrypted signal. In the present embodiment, the image sensor 422 of the image sensing apparatus 420, for example, emits a sensing signal to the electronic paper display apparatus 410, and the electronic paper display apparatus 410 feeds back the sensing signal to the image sensor 422 to make the image sensor 422 to receive the encrypted signal. It should be noted that the electronic paper display apparatus 410 displaying the first image absorbs at least a part of the sensing signal, and the electronic paper display apparatus 410 displaying the second image reflects at least a part of the sensing signal.

Generally, when the infrared sensing device senses the image displayed by the electronic paper display apparatus, a black part of the image may absorb an infrared ray (the sensing signal) emitted by the infrared sensing device, and a white part of the image may reflect the infrared ray (the sensing signal) emitted by the infrared sensing device. In the present embodiment, the infrared sensing device is, for example, adopted to serve as the image sensor 422, though the invention is not limited thereto. In this case, while the electronic paper display apparatus 410 alternately displays the first image constructed by the black display particles and the second image constructed by the white display particles, the infrared sensing device emits the infrared ray to the electronic paper display apparatus 410 to dynamically sense the encrypted signal transmitted by the electronic paper display apparatus 410. In this way, the electronic paper display apparatus 410 displaying the first image (black image) may absorb at least a part of the infrared ray, and the electronic paper display apparatus 410 displaying the second image (white image) may reflect at least a part of the infrared ray, such that the infrared sensing device may sense the encrypted signal transmitted by the images displayed by the electronic paper display apparatus 410 according to the feedback sensing signal.

Then, after the image sensor 422 receives the encrypted signal, the image sensor 422 transmits the encrypted signal to the data processor 424 for decoding. The data processor 424 may analyze the images of the electronic paper display apparatus 410 according to the encrypted signal transmitted by the image sensor and the corresponding encoding method (for example, the encoded signal with different frequencies or a combination thereof, though the invention is not limited thereto), so as to obtain information DD included in the encrypted signal. It should be noted that the encrypted signal transmitted through the signal transmission system 400 may be further encrypted in advance by using at least one algorithm. The image sensor 422, for example, has a corresponding post-end processing algorithm to decode the encrypted signal, so as to obtain the information DD included in the encrypted signal. In this way, the encrypted signal transmitted by the electronic paper display apparatus 410 is not only hard to be duplicated and stolen, a plurality of security measures may be adopted to enhance security of the signal transmission.

In brief, according to the signal transmission system and the method thereof of the invention, the transmitting end may transmit the encrypted signal through the measure that the electronic paper display apparatus alternately displays the first image and the second image. At the receiving end, an infrared sensing device may be adopted to sense the images alternately displayed by the electronic paper display apparatus, so as to receive the encrypted signal. Then, the data processor is configured to decode the encrypted signal to obtain the information included in the encrypted signal. In this way, not only the encrypted signal transmitted by the electronic paper display apparatus 410 is hard to be duplicated and stolen, a plurality of security measures may be adopted to enhance security of the signal transmission.

Besides, in the other embodiments of the invention, the electronic paper display panels 110 and 412 may also transmit the encrypted signal through a method different to the aforementioned display method. For example, the electronic paper display panel 412 may further include a plurality of display regions, and the display driver 414 drives each of the display regions of the electronic paper display panel 410 to alternately display the first image and the second image by using the driving signal DS, such that the electronic paper display panel transmit one of a plurality of encoded signal in the encrypted signal. The encoded signals transmitted by the electronic paper display panel 410 are, for example, determined according to combinations of the first image and the second image displayed by the display regions. Moreover, since enough instructions and recommendations for the signal transmission method and the panel driving method of the electronic paper display apparatus 410 of the present exemplary embodiment may be learned from the descriptions of the embodiments of FIG. 1 to FIG. 3, detailed description thereof is not repeated.

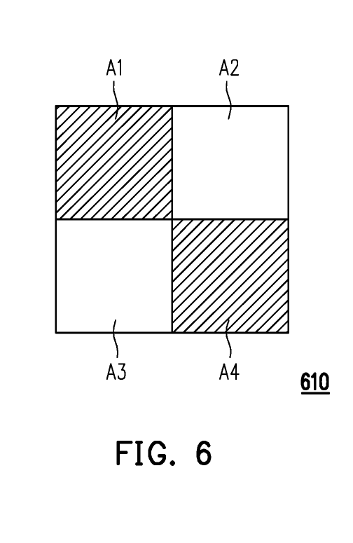

To be specific, referring to FIG. 6, FIG. 6 is a schematic diagram of a plurality of display regions of an electronic paper display panel according to an embodiment of the invention. In the present embodiment, the electronic paper display panel 610 includes a plurality of display regions A1, A2, A3 and A4. The electronic paper display panel 610 is driven by the driving signal DS to make each of the display regions A1, A2, A3 and A4 to respectively display the first image and the second image. For example, when the display regions A1 and A4 display the first image, and the display region A2 and A3 display the second image, a combination of the images may correspond to one of a plurality of encoded signals, and the encoded signals may be defined by the user, as shown in FIG. 6, though the invention is not limited thereto. In this way, the electronic paper display panel 610 of the present embodiment may produce more types of the encoded signal through combinations of the first image and the second image displayed by each of the display regions. Not only such encoded signal may be defined by the user, the electronic paper display panel 610 may also quickly switch the images to enhance security and confidentiality to transmit the encrypted signal. Moreover, since enough instructions and recommendations for the electronic paper display panel, the signal transmission method thereof and the panel driving method thereof provided by the exemplary embodiment of the invention may be learned from the descriptions of the embodiments of FIG. 1 to FIG. 5, detailed descriptions thereof are not repeated.

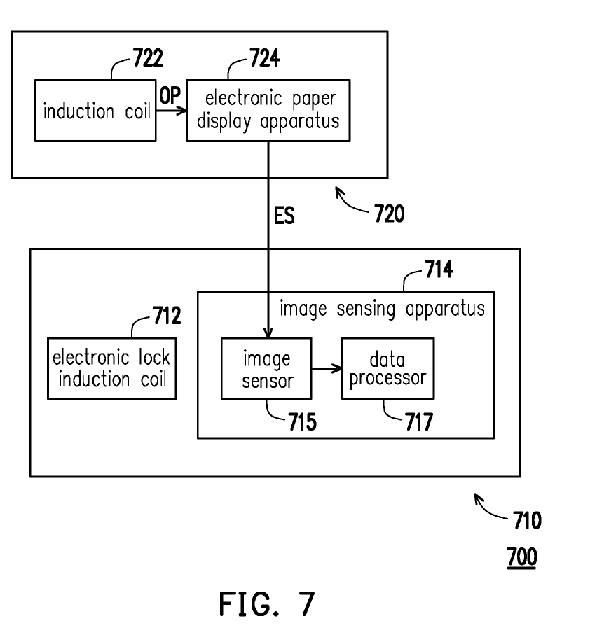

FIG. 7 is a schematic diagram of an intelligent authentication system according to an embodiment of the invention. Referring to FIG. 7, in the present embodiment, an intelligent authentication system 700 includes an electronic lock 710 and an electronic key 720. The electronic lock 710 includes an electronic lock induction coil 712 and an image sensing apparatus 714. The electronic key 720 includes an induction coil 722 and an electronic paper display apparatus 724. The electronic lock induction coil 712 arranged in the electronic lock 710 and the induction coil 722 arranged onto the electronic key 720 are configured to perform the first authentication step. The induction coil 722 arranged onto the electronic key 720 is coupled to the electronic paper display apparatus 724. When the induction coil 722 is applied in the first authentication step, the induction coil 722 transmits an operating electricity power OP to the electronic paper display apparatus 724, such that the electronic paper display apparatus 724 displays an encoded and encrypted message. The image sensing apparatus 714 arranged in the electronic lock 710 receives and decodes an encrypted message displayed by the electronic paper display apparatus 724 during the second authentication step. An authentication method of the intelligent authentication system 700 in the embodiment of the invention is described below in detail.

In the embodiment of the invention, during an authentication period of the electronic key 720 and the electronic lock 710, the electronic lock induction coil 712 arranged in the electronic lock 710 transmits an authentication message to the induction coil 722 on the electronic key 720 to perform a first authentication step. Authentications of the electronic lock 710 and the electronic key 720 may be performed through near field communication (NFC), radio frequency identification (RFID), or other techniques during the first authentication step. After the first authentication step is passed, the electronic lock induction coil 712 transmits the operating electricity power OP to the induction coil 722 on the electronic key 720. The operating electricity power OP is configured to drive the electronic paper display apparatus 724 arranged onto the electronic key 720. If the first authentication step is not passed, the electronic lock induction coil 712 does not transmit the operating electricity power OP to the induction coil 722 on the electronic key 720. In other words, the electronic lock 710 denies a request of the electronic key 720 for the first authentication step.

In other embodiments of the invention, the electronic key 720 may include a battery. When a first authentication step is passed, the electronic lock 710 provides a controlling signal to the electronic key 720, such that the operating electricity power OP in the battery of the electronic key 720 drives the electronic paper display apparatus 724.

In some embodiments of the invention, an electronic key 720 may be in contact with a surface of the electronic lock 710. During the period when the electronic key 720 and the electronic lock 710 contact each other, the electronic lock induction coil 712 transmits an authentication signal to the induction coil 722 to perform a recognition of a first authentication step. In some embodiments, the electronic key 720 may be close to but does not directly contact the surface of the electronic lock 710. During the period when the electronic key 720 is close to but does not contact the electronic lock 710, the electronic lock induction coil 712 transmits an authentication signal to the induction coil 722 to perform a recognition of the first authentication step. In some embodiments, the electronic lock 710 has a pinhole, and the electronic lock induction coil 712 is arranged in the pinhole of the electronic lock 710. During the period when the electronic key 720 is inserted into the pinhole of the electronic lock 710, the electronic lock induction coil 712 transmits an authentication signal to the induction coil 722 to perform a recognition of the first authentication step.

In some embodiments of the invention, the electronic lock 710 may provide a warning sound or a warning signal when the electronic key 720 fails to pass the first authentication step, so as to notify a user possessing the electronic key 720 of the fact that the first authentication step is not passed.

Please refer to FIG. 7. In the embodiment of the invention, after the electronic paper display apparatus 724 arranged onto the electronic key 720 is driven, the electronic paper display apparatus 724 alternately displays a plurality of encoded signals generated by combining the first image and the second image during the second authentication step, so as to transmit an encrypted signal ES. The encrypted signal ES is set by a user, for instance, a password or an identification code and is then encoded and encrypted. In some embodiments, the user may perform an information setting process on the electronic lock 710. After the setting process, the electronic lock 710 performs an encoding and encrypting operation on the information set by the user through performing an encoding method determined by a system or the user, so as to convert the information into an encrypted signal ES. Afterwards, near field communication (NFC), radio frequency identification (RFID), or other techniques may be applied to transmit the encrypted signal ES generated by the electronic lock 710 to the electronic key 720 which passes the first authentication step and the second authentication step. In some embodiments, the electronic key 710 that passes the first authentication step and the second authentication step may obtain a driving signal containing the encrypted signal ES through contacting an electronic lock 720. In some embodiments, the electronic key 710 that passes the first authentication step and the second authentication step may obtain a driving signal containing the encrypted signal ES through approaching but not contacting the electronic lock 720. In some embodiments, the electronic lock 710 has a pinhole, and the electronic lock induction coil 712 is arranged in the pinhole of the electronic lock 710. During the period when the electronic key 720 is inserted into the pinhole of the electronic lock 710, the electronic key 720 that passes the first authentication step and the second authentication step may be inserted into the pinhole of the electronic lock 710, so as obtain a driving signal containing the encrypted signal ES.

In some embodiments of the invention, an electronic paper display apparatus 724 may have an encoding function to encode an internal signal or a received external signal. In other words, the electronic paper display apparatus 724 is capable of encoding a signal set by a user and received by the electronic key 720 or encoding a signal (e.g., a password or an identification code) stored in an electronic lock 710 to generate the encrypted signal ES. However, the invention is not limited thereto.

In some embodiments of the invention, a user may set an information, e.g., a password or an identification code, on a mobile phone, a computer, or an information-processing interface. The user may then send the information to the electronic lock 710 through wireless transmission, Bluetooth, radio frequency identification (RFID), or near field communication (NFC), such that the electronic lock 710 transmits the information to the electronic key 720 that is able to pass the first authentication step and the second authentication step through a transmission between the electronic lock induction coil 712 and the induction coil 722. However, the invention is not limited thereto.

In some embodiments of the invention, the electronic paper display apparatus 724 arranged onto the electronic key 720 is capable of increasing the complexity of a password or an encoding method to receive a more complex encrypted signal ES and display a more complex combination of encoded signals ES according to a resolution of the electronic paper display apparatus 724 itself. In some embodiments, the electronic paper display apparatus 724 may further choose to switch between a plurality of encoded signals during the second authentication step. An encoded signal containing the encrypted signal ES is thus displayed dynamically, and the complexity of displaying the encrypted signal ES is further improved. In other words, the intelligent authentication system 700 is capable of increasing the complexity of setting and encoding the encrypted signal ES according to a high image resolution and a high image-switching speed of the electronic paper display apparatus 710. Thereby, the security of signal transmission in the intelligent authentication system 700 during the second authentication step is further improved.

Please refer to FIG. 7. In the embodiment of the invention, the image sensing apparatus 714 arranged on the electronic lock 710 includes an image sensor 715 and a data processor 717. The image sensor 715 is configured to receive the encrypted signal ES from the electronic paper display apparatus 724 and output the encrypted signal ES to the data processor 717 during the second authentication step. The data processor 717 is configured to decode the encrypted signal ES received from the image sensor 715, so as to obtain an information, for example a password or an identification code, included in the encrypted signal ES before the encoding process and the encrypting process are performed. The data processor 717 compares the information obtained after decoding with the information stored in the electronic lock 710. If the information obtained by the data processor 717 through decoding matches the information stored in the electronic lock 710, it indicates that the electronic key 720 requesting for authentication passes the first authentication step and the second authentication step, and the data processor 717 opens the electronic lock 710. If the electronic key 720 fails to pass the second authentication step, the electronic lock 710 is not opened. In other words, the electronic lock 710 denies a request from the electronic key 720 for performing the second authentication step. In some embodiments, the image sensing apparatus 714 may be arranged in the pinhole of the electronic lock 710 or on a surface of the electronic lock 710 according to an authentication method between the electronic lock 710 and the electronic key 720, whereas the invention is not limited thereto. Moreover, since the electronic paper display panel, the signal transmission thereof, and the panel driving method in the present embodiment have been sufficiently taught and suggested by the descriptions in the embodiments depicted in FIG. 1 to FIG. 6, no further explanation is provided hereinafter.

In some embodiments of the invention, the electronic lock 710 may provide a warning sound or a warning signal if the electronic key 720 does not pass the second authentication step, so as to notify a user possessing the electronic key 720 of the fact that the second authentication step is not passed.

When the electronic key 720 requesting for authentication passes the first authentication step and the second authentication step, the image on the electronic paper display apparatus 724 is replaced with a pre-determined reset image according to an internally pre-determined reset signal. The pre-determined reset signal may also be set by the user, which should not be construed as a limitation to the invention.

To sum up, the driving signal of the intelligent authentication system provided in the embodiments of the invention includes a password or an identification code to be transmitted, so as to drive the electronic paper display panel to quickly and alternately display different images during a signal transmission period for transmitting an encrypted signal. When the electronic paper display apparatus switches the display images, the image sensing apparatus senses the images alternately displayed by the electronic paper display apparatus to receive and decode the encrypted signal and thereby obtain the information included in the encrypted signal. Moreover, the electronic paper display panel may further include a plurality of display regions to generate the encoded signals of more varieties. As a result, it is rather difficult to duplicate and steal the encrypted signal transmitted through the electronic paper display apparatus, and the security of signal transmission may be further improved through taking the security measures of performing a plurality of authentication steps.

It will be apparent to those skilled in the art that various modifications and variations may be made to the structure of the invention without departing from the scope or spirit of the invention. In view of the foregoing, it is intended that the invention cover modifications and variations of this invention provided they fall within the scope of the following claims and their equivalents.

What is claimed is:

1. An intelligent authentication system, comprising:
an electronic lock; and
an electronic key, comprising an electronic paper display apparatus and adapted to perform a two-step authentication, wherein the two-step authentication comprises a first authentication step and a second authentication step,
wherein the electronic paper display apparatus is driven after the first authentication step is passed, and the electronic key performs an authentication operation with the electronic lock during the second authentication step by using the driven electronic paper display apparatus.

2. The intelligent authentication system according to claim 1, wherein the electronic key further comprises:
an induction coil performing another authentication operation through near field communication (NFC) with the electronic lock during the first authentication step,
wherein the induction coil outputs an operating electricity power to the electronic paper display apparatus to drive the electronic paper display apparatus after the first authentication step is passed.

3. The intelligent authentication system according to claim 1, wherein the electronic lock comprises an image sensing apparatus, and the electronic lock performs the authentication operation with the electronic key by using the image sensing apparatus,
wherein the electronic paper display apparatus alternately displays a first image and a second image during the second authentication step to transmit an encrypted signal, and the image sensing apparatus receives and decodes the encrypted signal during the second authentication step, so as to obtain information contained in the encrypted signal to perform the authentication operation.

4. The intelligent authentication system according to claim 3, wherein the encrypted signal comprises a combination of the first image and the second image displayed by the electronic paper display apparatus during the second authentication step.

5. The intelligent authentication system according to claim 3, wherein the electronic paper display apparatus is driven by a driving signal comprising a first frequency and a second frequency, wherein the driving signal of the first frequency drives the electronic paper display apparatus to transmit an encoded signal contained in the encrypted signal, and the driving signal of the second frequency drives the electronic paper display apparatus to transmit another encoded signal contained in the encrypted signal, wherein the first frequency is not equal to the second frequency.

6. The intelligent authentication system according to claim 3, wherein the electronic paper display apparatus is driven by the driving signal of a plurality of different frequencies to transmit one of a plurality of encoded signals contained in the encrypted signal, wherein the encoded signals transmitted by the electronic paper display apparatus are determined by a combination of the different frequencies.

7. The intelligent authentication system according to claim 3, wherein the image sensing apparatus comprises:
an image sensor configured to receive the encrypted signal and output the encrypted signal; and
a data processor electrically connected to the image sensor and configured to decode the encrypted signal to obtain information contained in the encrypted signal.

8. The intelligent authentication system according to claim 7, wherein the image sensor emits a sensing signal to the electronic paper display apparatus, and the electronic paper display apparatus feeds back the sensing signal to the image sensor, such that the image sensor receives the encrypted signal,
wherein the electronic paper display apparatus displaying the first image absorbs at least a part of the sensing signal, and the electronic paper display apparatus displaying the second image reflects at least a part of the sensing signal.

9. An electronic key adapted to an intelligent authentication system, the electronic key comprising:
an electronic paper display apparatus, the electronic key being adapted to perform a first authentication step and a second authentication step with the intelligent authentication system, wherein the electronic paper display apparatus is driven after the first authentication step is passed, and the electronic key performs an authentication operation with the intelligent authentication system during the second authentication step by using the driven electronic paper display apparatus.

10. The electronic key according to claim 9, further comprising:
an induction coil performing another authentication operation through near field communication (NFC) with the intelligent authentication system during the first authentication step,
wherein the induction coil outputs an operating electricity power to the electronic paper display apparatus to drive the electronic paper display apparatus after the first authentication step is passed.

11. The electronic key according to claim 9, wherein the electronic paper display apparatus alternately displays a first image and a second image during the second authentication step for transmitting an encrypted signal.

12. The electronic key according to claim 11, wherein the encrypted signal comprises a combination of the first image and the second image displayed by the electronic paper display apparatus during the second authentication step.

13. The electronic key according to claim 11, wherein the electronic paper display apparatus is driven by a driving signal comprising a first frequency and a second frequency, wherein the driving signal of the first frequency drives the electronic paper display apparatus to transmit an encoded signal contained in the encrypted signal, and the driving signal of the second frequency drives the electronic paper display apparatus to transmit another encoded signal contained in the encrypted signal, wherein the first frequency is not equal to the second frequency.

14. The electronic key according to claim 11, wherein the electronic paper display apparatus is driven by the driving signal of a plurality of different frequencies to transmit one of a plurality of encoded signals contained in the encrypted signal, wherein the encoded signals transmitted by the electronic paper display apparatus are determined by a combination of the different frequencies.

15. The electronic key according to claim 11, wherein the image sensing apparatus comprises:
an image sensor configured to receive the encrypted signal and output the encrypted signal; and
a data processor electrically connected to the image sensor and configured to decode the encrypted signal to obtain information contained in the encrypted signal.

16. The electronic key according to claim 15, wherein the image sensor emits a sensing signal to the electronic paper display apparatus, and the electronic paper display apparatus feeds back the sensing signal to the image sensor, such that the image sensor receives the encrypted signal,
wherein the electronic paper display apparatus displaying the first image absorbs at least a part of the sensing signal, and the electronic paper display apparatus displaying the second image reflects at least a part of the sensing signal.
